(19) United States
(12) Patent Application Publication
(10) Pub. No.: US 2026/0119804 A1
(43) Pub. Date: Apr. 30, 2026

(54) FORMATIVE FEEDBACK ENGINE(S) FOR PROVIDING COMMENTARY INSIGHTS ON TEXT-BASED ASSESSMENTS

(71) Applicant: Microsoft Technology Licensing, LLC, Redmond, WA (US)

(72) Inventors: Ella BEN TOV, Tel Aviv (IL); Shay BEN-ELAZAR, Herzliya (IL); Leif Christian BRENNE, Snoqualmie, WA (US)

(21) Appl. No.: 18/928,604

(22) Filed: Oct. 28, 2024

(51) Int. Cl. G06F 40/35

(52) U.S. Cl. CPC G06F 40/35

(57) ABSTRACT

Systems and methods for a formative feedback engine for providing a formative feedback engine and its functions are provided herein. In an example, the formative feedback engine may receive a written assessment from a drafting user and identify content therein. Based on the content, the formative feedback engine may generate a commentary insight based on feedback on similar content that was previously submitted. The commentary insight may be generated in an evaluation style of a reviewing user (e.g., educator). The reviewing user may review the commentary insight and modify the insight as needed before the commentary insight is provided to the drafting user, such as displayed within the written assessment for context.

### TECHNICAL FIELD

Aspects of the disclosure are related to the field of computer software applications and services and, in particular, to formative feedback engines for providing commentary insights on text-based assessments.

### BACKGROUND

Written communication plays a vital role in nearly every aspect of modern life, from professional settings to personal interactions. It is the primary means by which ideas, instructions, and information are shared across distances, making it indispensable in the digital age. Effective written communication not only conveys a message but also ensures clarity, precision, and understanding, which are essential for collaboration, decision-making, and problem-solving. Whether in business, education, or everyday correspondence, the ability to communicate clearly through writing helps build relationships, promote ideas, and facilitate the smooth exchange of knowledge.

To develop writing skills, various forms of written assessments, such as essays and research papers, are commonly assigned within educational environments. These tasks encourage students to organize their thoughts, articulate ideas, and present arguments in a structured and coherent manner. By engaging in the writing process, students practice critical thinking, research, and the ability to communicate complex concepts clearly. Feedback provided by teachers or peers on these assignments further refines their skills, helping them recognize areas for improvement, such as grammar, tone, and structure. Over time, these exercises build a strong foundation for effective written communication that extends beyond the classroom into professional and personal contexts.

Under conventional approaches, educators must read and evaluate each written assessment in its entirety, providing detailed feedback on content, structure, grammar, and overall effectiveness for every individual student under their supervision. This process can be especially time-consuming when assignments are lengthy, such as essays or research papers. For each assessment, educators must carefully review the argumentation, accuracy of information, and clarity of expression, often requiring them to reread sections to ensure fairness and precision. Compounding this challenge is the fact that educators frequently provide the same or similar feedback across multiple assignments, addressing common issues like unclear thesis statements, weak transitions, or grammatical errors. Repeatedly writing out these corrections for different students not only extends the time required but also makes the task more laborious, especially when managing a large number of students. This can ultimately limit the depth and timeliness of the personalized feedback educators aim to provide.

Accordingly, there is a need for a formative feedback engine, and its related functions, for providing commentary insights on a written assessment. That is, there is a need for a formative feedback engine that generates and provides clear, concise, and targeted feedback on a written assessment to enable individuals to make meaningful revisions, foster growth, and hone their written communication skills.

### SUMMARY

Technology disclosed herein includes software applications and services that provide a formative feedback engine, and its related functions, for providing commentary insights on written assessments, such as essays or reports. As described in greater detail below, a formative feedback engine may receive a written assessment prepared by a user, such as a student. From the written assessment, the formative feedback engine may identify first content, such as a statement, sentence, or paragraph within the written assessment. Based on the first content, the formative feedback engine may identify textual feedback that was provided to similar content previously. For example, the formative feedback engine may identify a similar statement to the first content made in a previously submitted assignment and identify associated textual feedback that was provided by a reviewing user (e.g., educator).

Based on the textual feedback, and in some embodiments the first content from the written assessment, the formative feedback engine may generate a commentary insight for the first content. For example, the formative feedback engine may modify the textual feedback to be tailored to the first content and, in some cases, in the feedback style of the reviewing user. Once generated, the commentary insight may be provided to the reviewing user for review, modification, or approval. Once modifications and/or approval of the commentary insight is received, the formative feedback engine may provide the commentary insight to the drafting user (e.g., student). For example, the commentary insight may be displayed within visual proximity of the first content within the written assessment on a client device associated with the drafting user.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for providing a formative feedback engine, according to an embodiment herein;

FIG. 2 illustrates a brief operational scenario to further highlight an application of the formative feedback engine, according to an embodiment provided herein;

FIG. 3 illustrates a system for providing a formative feedback engine and related functions, according to an embodiment herein;

FIG. 4 illustrates a process for providing the formative feedback engine and its related functions, according to an embodiment herein;

FIG. 5 illustrates an example prompt requesting input on a commentary insight generated by the formative feedback engine of FIG. 3, according to an embodiment herein;

FIG. 6 illustrates an example written assessment containing commentary insights, according to an embodiment herein;

FIG. 7 illustrates an example summary of the commentary insights generated by the formative feedback engine of FIG. 3, according to an embodiment herein; and

FIG. 8 shows an example client device suitable for providing a formative feedback engine and related functions, according to an embodiment herein.

### DETAILED DESCRIPTION

Written communication is essential in nearly every aspect of modern life, from professional settings to personal interactions, as it serves as the primary means of sharing ideas, instructions, and information across distances. In the digital age, effective written communication ensures clarity, precision, and understanding, which are crucial for collaboration, decision-making, and problem-solving. Writing skills are typically developed through various forms of written assessments, such as essays and research papers, assigned in educational environments. These tasks encourage students to organize their thoughts, articulate ideas, and present arguments in a structured and coherent manner, while engaging in critical thinking and research. The feedback provided by educators or peers further refines these skills, guiding students to recognize and improve areas such as grammar, tone, and structure. Over time, this process builds a strong foundation for effective written communication that extends well beyond the classroom and into personal and professional contexts.

Despite the importance of developing effective writing skills, educators often face challenges in providing adequate feedback on written assessments. Constructive and targeted feedback, especially on longer assignments like essays or research papers, requires significant time and effort to review each student's work thoroughly. Educators must assess various elements, including content, structure, factual accuracy, and the clarity of arguments, while offering personalized guidance for improvement. This process becomes even more demanding as classroom sizes continue to grow, leaving educators responsible for more students. The increasing number of students amplifies the time intensity of reviewing each written assessment, making it difficult for educators to provide detailed and timely feedback. As a result, the strain of managing larger classrooms while delivering meaningful evaluations can be overwhelming, limiting the depth and quality of feedback students receive.

In addition to being time-intensive, providing feedback on writing assessments is often a repetitive process for educators. Common writing issues, such as unclear thesis statements, weak organization, or recurring factual errors, tend to appear across multiple student assignments. As a result, educators frequently find themselves offering the same or similar feedback to different students, addressing these recurring issues. This repetition can further add to the workload, as educators must not only identify and explain the same types of problems but also tailor their feedback to each student's specific work. The cumulative effect of providing this repetitive feedback across large classes makes the assessment process even more demanding, adding to the already considerable time and effort required to give each student individualized guidance.

From the student's perspective, waiting until an assignment is completed and submitted to receive feedback can be equally challenging. This delay means that students may be unaware of mistakes or areas for improvement as they work, missing the opportunity to correct their approach during the writing process. Without timely feedback, students are left to complete assignments without clear guidance, potentially reinforcing poor writing habits or misunderstanding key concepts. By the time they receive feedback, the opportunity for immediate improvement has passed, and they may have to wait until the next assignment to apply any lessons learned. This lag in feedback can slow the development of writing skills, leaving students feeling disconnected from the learning process and unsure of how to improve in real-time.

To address these and other shortcomings, an example formative feedback engine, and its related functions, is provided herein to provide commentary insights on written assessments. As will be expanded on below, the formative feedback engine provided herein may receive a written assessment, such as an essay, a report, or a research paper, from a respective client device. Responsive to receiving the written assessment, the formative feedback engine may act as an unintrusive assistant to the reviewer (e.g., educator) and analyze the content of the written assessment to identify areas requiring feedback. Once content, such as a statement or paragraph, is identified, the formative feedback engine may generate a commentary insight to provide feedback on the content. In some cases, the commentary insight may be generated based on previous feedback provided by the reviewer, such that the commentary insight reflects the reviewing style of that specific reviewer.

The formative feedback engine may also provide feedback to the drafting users (e.g., students) as they prepare the written assessment. For example, as a student drafts an essay, the formative feedback engine may review the content and provide suggestions or hints to support and guide the student during the drafting process. By providing feedback during the drafting process, the formative feedback engine provides learning opportunities beyond conventional, educator-only approaches to reviewing written assessments.

By providing concise, targeted feedback on written assessments in a timely manner, the formative feedback engine offers significant benefits over conventional approaches. The formative feedback engine helps students hone their writing skills by providing specific and actionable feedback, thereby allowing them to focus on key areas such as argument clarity, organization, or grammar. By offering feedback during the drafting process, the formative feedback engine allows students to make real-time corrections and adjustments before submitting their final work, enhancing the quality of their writing and fostering a more active learning process. Moreover, once the assessment is submitted, the formative feedback engine aids reviewers in providing timely feedback, thereby reinforcing lessons learned, giving students the opportunity to reflect on their performance and apply improvements to future assignments. By identifying content requiring feedback and generating commentary insights based on previous feedback from the reviewer, the formative feedback engine can drastically reduce the amount of time required to review each assignment while ensuring that each assessment receives adequate and thorough feedback. By providing a continuous cycle of guidance, both during and after the writing process, the formative feedback engine accelerates skill development, promotes confidence, and ultimately leads to stronger, more effective communication abilities.

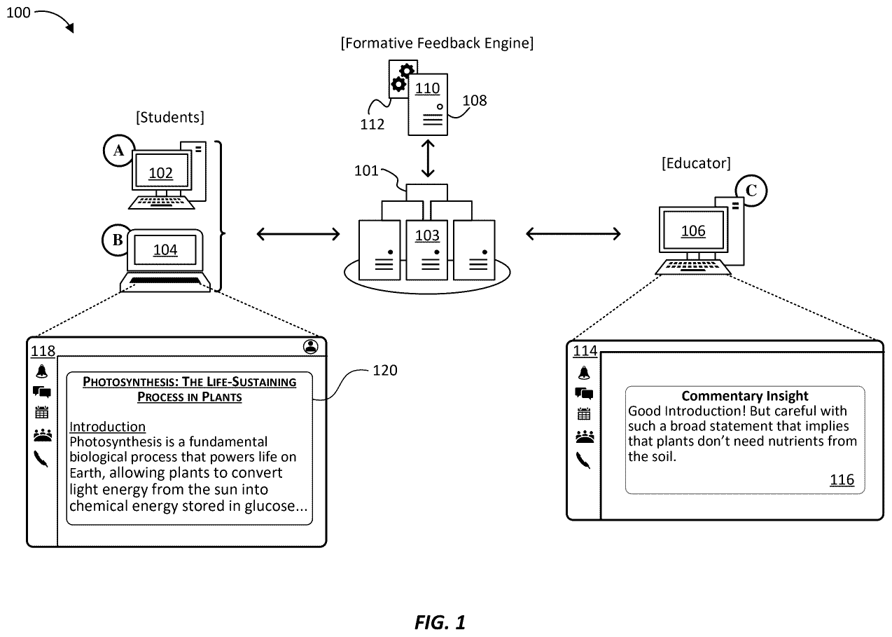

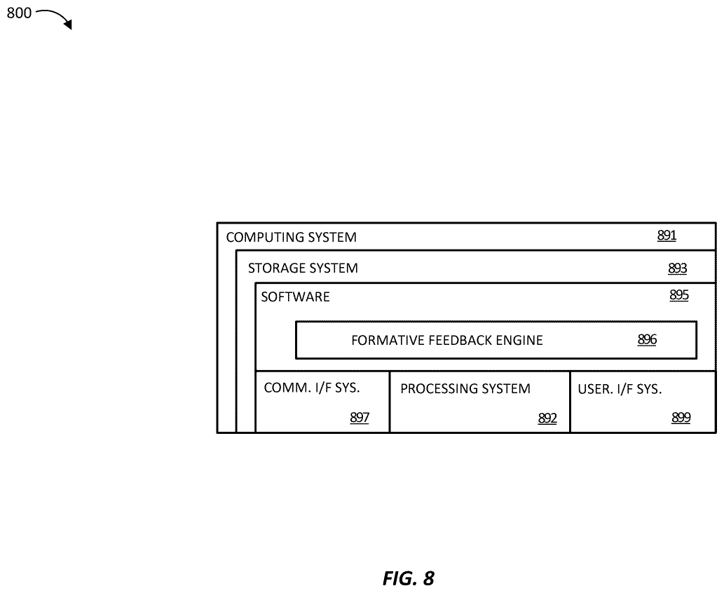

Turning now to FIG. 1, FIG. 1 illustrates an operational environment 100 providing a formative feedback engine 108, according to an embodiment herein. As illustrated, the operational environment 100 includes an application service 101, the formative feedback engine 108, and client devices 102, 104 and 106. The application service 101 employs one or more server computers 103 co-located with respect to each other or distributed across one or more data centers. Example servers include web servers, application servers, virtual or physical servers, or any combination or variation thereof, of which computing system 801 in FIG. 8 is broadly representative.

The client devices 102, 104, and 106 communicate with application service 101 via one or more internets and intranets, the Internet, wired and wireless networks, local area networks (LANs), wide area networks (WANs), or any other type of network or combination thereof. Examples of the client devices 102, 104, and 106 may include personal computers, tablet computers, mobile phones, gaming consoles, wearable devices, Internet of Things (IoT) devices, and any other suitable devices, of which computing system 801 in FIG. 8 is also broadly representative.

Broadly speaking, the application service 101 provides software application services to end points, such as the client devices 102, 104, and 106, examples of which include productivity software for creating content (e.g., word processing, spreadsheets, and presentations), email software, and collaboration software. The client devices 102, 104, and 106 load and execute software applications locally that interface with services and resources provided by the application service 101. The applications may be natively installed and executed applications, web-based applications that execute in the context of a local browser application, mobile applications, streaming applications, or any other suitable type of application. Example services and resources provided by the application service 101 include front-end servers, application servers, content storage services, authorization and authentication services, and the like.

The application service 101 also includes an integration with the formative feedback engine 108, which is capable of generating commentary insights on written assessments (e.g., essays, reports) submitted by the client devices 102 and 104. As will be described in greater detail below, one or more users of the client devices 102 and 104 may draft a written assessment, such as completing an assignment, via the application service 101. For example, the application service 101 may provide a writing application through which the formative feedback engine 108 provides one or more of its functions. As respective users of the client devices 102 and 104 draft a written assessment, the formative feedback engine 108 may receive content from the client devices 102 and 104. Based on the received written assessment, the formative feedback engine 108 may identify content requiring feedback, and responsively generate commentary insights. As used herein, written assessments encompass various forms, each of which may be designed to develop different skills, including essays, research papers, reports, creative writing, case studies, and reflective journals, as well as more focused formats like short answer questions, lab reports, and literature reviews.

To provide these functions, the formative feedback engine 108 employs one or more server computers 110 co-located with respect to each other or distributed across one or more data centers, of which computing system 801 in FIG. 8 is broadly representative. In some embodiments, the formative feedback engine 108 hosts a content generator 112 on server computer(s) 110 as well. In other embodiments, the content generator 112 may be hosted separately from the formative feedback engine 108, such as by a third party. As will be described in greater detail below, the formative feedback engine 108 interacts with a user via the content generator 112, such as a large language model (LLM).

The application service 101 hosts or provides an application, such as a writing application, through which users of the client devices 102 and 104, user A and user B, respectively, can practice or develop their writing skills, and/or complete writing assignments, such as performing a written assessment 120. For example, the application service 101 may provide or host an educational application through which exercises are prepared by an educator, such as the user of the client device 106 (user C). Users A and B may be students in the illustrated example. As such, users A and B may perform and complete one or more writing assignments provided by the application service 101 via a corresponding writing application.

As the users A and B complete a respective writing assessment 120, the formative feedback engine 108 may generate commentary insights on the respective user's drafted content. For example, during the drafting process, the user B may select an option to “self-assess” his or her writing assessment 120. As such, as user B generates content for the written assessment 120, the formative feedback engine 108 may analyze the content to identify areas requiring feedback. In some cases, the formative feedback engine 108 may identify content issues, such as factual mistakes, contradictions, miswording, and the like. Based on the identified content, the formative feedback engine 108 may generate and provide commentary insights for content as identified as requiring feedback. Based on the commentary insights, the user B can revise or update the written assessment 120 before submitting it.

Once the written assessment 120 is submitted by a user, such as user A or B, the written assessment 120 may be provided to a reviewing user, such as the user C. In parallel or prior to the written assessment 120 being provided to the client device 106, the formative feedback engine 108 may receive the written assessment 120. Responsive to receiving the written assessment 120, the formative feedback engine 108 may generate commentary insights for the written assessment 120 and provide the commentary insights to the client device 106.

To generate the commentary insights, such as a commentary insight 116, the formative feedback engine 108 may query a semantic store to identify similar content to the content identified within the written assessment 120. As will be described in greater detail below, this may include generating a semantic representation of content within the written assessment 120 and comparing it to other representations stored within the semantic store. Once a similar representation or a semantically equivalent content is identified, the formative feedback engine 108 may determine textual feedback associated with the semantically equivalent content. In some cases, the formative feedback engine 108 may identify textual feedback that was previously given by user C. In other words, the formative feedback engine 108 identifies similar content from previous written assessments to which the user C provided feedback and generates commentary insights for the current written assessment 120 based on the previous feedback provided by the user C. Using the textual feedback and, in some cases the content from the written assessment 120, the formative feedback engine 108 generates the commentary insight 116.

Once generated by the formative feedback engine 108, the commentary insight 116 may be provided to user C, who may be an educator in this scenario, along with the written assessment 120 via a user interface 114. The user interface 114 may be provided via an application executing on the client device 106. That is, the formative feedback engine 108 may provide the written assessment 120 with the commentary insight 116 as associated with respective content within the written assessment for user C to review and/or modify. Upon reviewing the commentary insight 116, the user C may modify, change, or remove the commentary insight 116 from the written assessment 120.

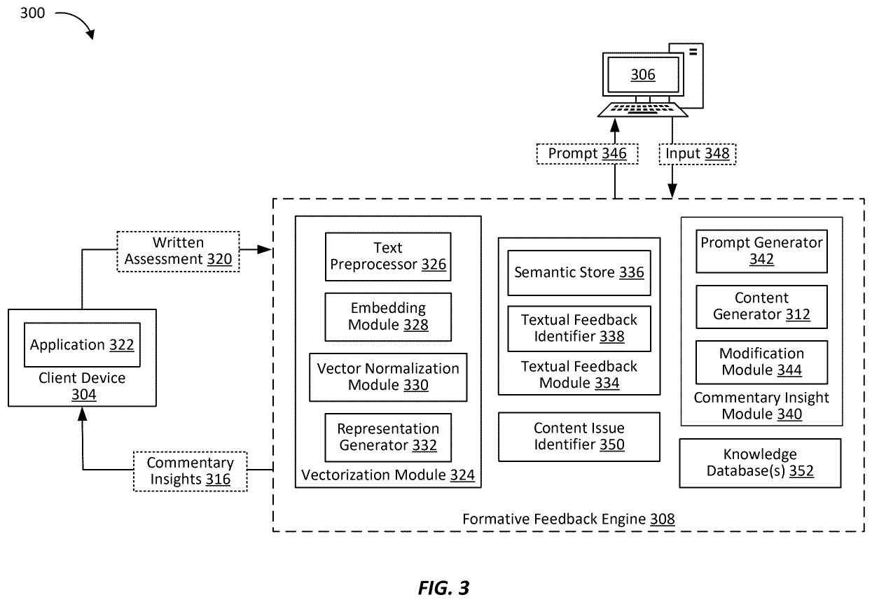

Once the user C provides input on the commentary insight 116, such as approval or modifying the commentary insight 116, as well as any other commentary insights generated for the written assessment 120, including those generated by user C, feedback for the written assessment 120 may be provided to user B via a user interface 118 of an application (e.g., writing application) executing on the client device 104. As will be described in greater detail below, the feedback may be provided as part of or on the written assessment 120. User B can interact with the written assessment 120 and respective feedback via the user interface 118, such as reviewing the commentary insights. Generation of the commentary insights is described in greater detail below with respect to FIGS. 3-7.

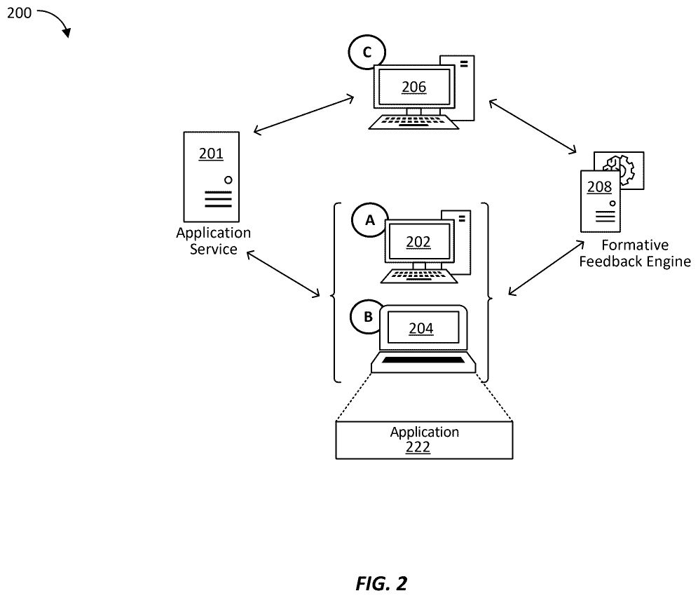

Turning now to FIG. 2, FIG. 2 illustrates a brief operational scenario 200 to further highlight an application of the formative feedback engine, according to an embodiment provided herein. As shown, in operational scenario 200, there are two drafting users (e.g., students), users A and B, and a reviewing user (e.g., educator), user C. Users A and B may operate the client devices 202 and 204, respectively, which may be the same or similar to the client devices 102 and 104 described above with respect to FIG. 1. Similarly, user C may operate the client device 206, which may be the same or similar to the client device 106. It should be appreciated while the following description includes a reviewing user associated with the client device 204, in some embodiments, there may not be a reviewing user. In other words, in some embodiments, the operational scenario 200 may include a sole user, such as user A or user B associated with a respective client device 202 or 204.

In the illustrated example, the user B may open an application, such as a writing application 222 (e.g., an education-based collaboration application), to begin a writing assessment, such as writing an essay on Photosynthesis. To open the application 222, the client device 204 may communicate with an application service 201, which may be the same or similar to the application service 101. The application service 201 may initiate and operate the writing application 222 on the client device 204. Once the application is open on the client device 204, the user B may begin drafting the Photosynthesis essay within the writing application 222 by, for example, typing or writing directly into the writing application 222 provided by the client deice 204 or utilizing any available input methods such as voice-to-text or stylus-based handwriting.

As noted above, the writing application 222 provides enhanced and targeted writing feedback on writing assessments as generated by formative feedback engine 208. The formative feedback engine 208 may be the same or similar to the formative feedback engine 108. As such, in some embodiments, upon initiating the writing application 222 on the client device 204, software corresponding to the formative feedback engine 208 may also be initiated. That is, settings associated with the writing application 222 may indicate a certain exercise is supported or guided by the formative feedback engine 208. For example, if the user C is an educator, the user C may have assigned the writing assessment to be completed in the writing application 222 and selected to allow for drafting guidance from the formative feedback engine 108 prior to submission of the assignment. Additionally, as part of the exercise, the user C may have selected a setting to have the formative feedback engine 208 generate commentary insights responsive to completion of the written assessment. As such, the formative feedback engine 108 may generate commentary insights and provide those commentary insights to the user B to guide his or her during drafting of the written assessment. Additionally, once the written assessment is submitted, the formative feedback engine 208 may also generate commentary insights and provide them to the user C via the client device 206 for review and editing. Once the user C provides any desired modifications to the commentary insights, including adding his or her own, the formative feedback engine 208 may provide the feedback to the user B, such as via the writing application 222.

Turning now to FIG. 3, a system 300 for providing a formative feedback engine 308 is illustrated, according to an embodiment herein. The system 300 includes the formative feedback engine 308 and a client device 304, which may be the same or similar to the formative feedback engine 108 and the client device 104, respectively. In the illustrated example, the formative feedback engine 308 analyzes a written assessment 320 prepared by a user of the client device 304 and generates commentary insights 316 to provide feedback on the written assessment 320. For ease of discussion the user of the client device 304 is described as a student within an educational environment, however, it should be appreciated that other scenarios are also contemplated, such as the user of the client device 304 using the formative feedback engine 308 in a personal capacity.

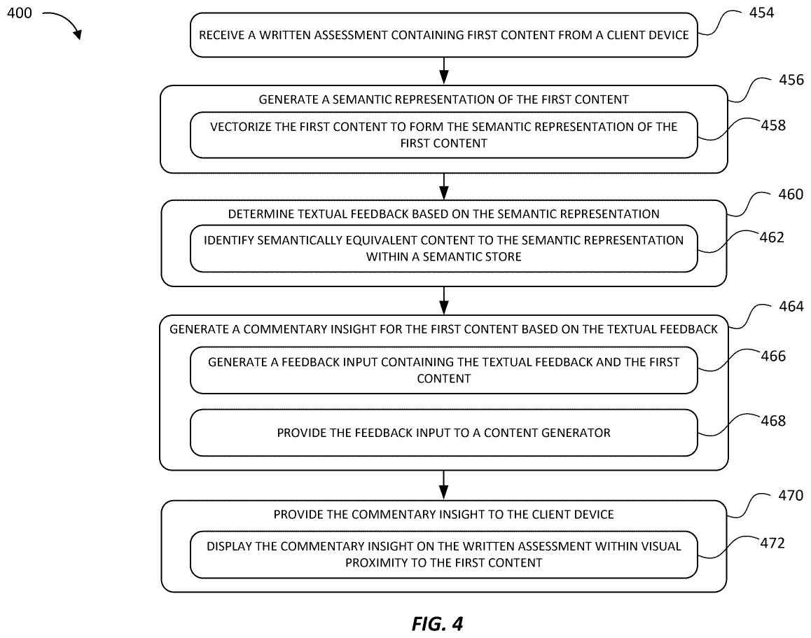

For ease of explanation, FIG. 3 is described in combination with FIGS. 4-7. As such, the following discussion may refer to various figures in turn. In particular, FIG. 3 is described with relation to FIG. 4 which illustrates a process 400 for providing the formative feedback engine 308 and its related functions, such as for providing the commentary insights 316 based on the written assessment 320, according to an embodiment herein. The process 400 may be referred to herein as the formative feedback engine process 400. Although the process 400 is described with respect to components and elements of FIG. 3, it should be appreciated the one or more steps of the process 400 may be executed or applied to components or elements of any other Figure provided herein.

To begin, the user corresponding to the client device 304 may start a writing assignment, such as the written assessment 320. For example, the client device 304 provides an indication, such as opening a writing application 322, to begin a writing assignment. Responsive to opening the writing application 322, the user may begin drafting the written assessment 320 within the writing application 322. As illustrated, the formative feedback engine 308 may receive the written assessment (454). In some cases, as the user drafts the written assessment 320, the formative feedback engine 308 may receive the draft of the written assessment 320. As noted above, the formative feedback engine 308 may be integrated with the writing application 322, and in such scenarios, the formative feedback engine 308 may receive the content of the writing assessment 320 as drafted in real time from the client device 304. In other embodiments, such as those in which an educator selects to disable the formative feedback engine 308 during the drafting process, the formative feedback engine 308 may receive the written assessment 320 upon completion or submission by the client device 304.

In cases where the formative feedback engine 308 receives drafts of the written assessment 320 during the drafting process, the formative feedback engine 308 may perform one or more of the following functions at predetermined time intervals (e.g., every 15 minutes), when a sufficient amount of new content is received, or upon request from the client device 304. For example, the formative feedback engine 308 may generate commentary insights 316 for a draft of the written assessment 320 when a user of the client device 304 selects an option to generate the commentary insights 316. As can be appreciated, it may be beneficial for the formative feedback engine 308 to receive completed sentences, paragraphs, or sections of the written assessment 320 before performing its analysis and generating the commentary insights 316 to allow the drafting user to complete his or her thoughts, statements, or arguments.

The written assessment 320 may include various content. As used herein, content may refer to a statement, a sentence, an argument, a table, a graph, a paragraph, or the like that is drafted by the user of the client device 304 as part of the written assessment 320. For example, the written assessment 320 may be an essay on Photosynthesis and as such include an introduction section, a section on the process of Photosynthesis, a section on the importance of Photosynthesis for life on Earth, and a conclusion section. Each of these sections, or statements made within each section, may be identified by the formative feedback engine 308 as content.

Responsive to receiving the written assessment 320, the formative feedback engine 308 may generate a semantic representation of a first content within the written assessment 320 (456). For example, the formative feedback engine 308 may receive a draft of the written assessment 320 as the user of the client device 304 works on the assignment. From the written assessment 320 as drafted, the formative feedback engine 308 may identify the introduction section as a first content and a section on the photosynthesis process as a second content. As such, the formative feedback engine 308 may generate a semantic representation of the introduction section and a semantic representation of the photosynthesis process. It should be appreciated that while the following discussion focuses on generating a semantic representation of a section of the writing assessment 320, the semantic representation may be generated based on any sectioning of the written assessment 320, as well as overlapping sections within the written assessment 320. For example, a semantic representation may be generated for each sentence or for the entire written assessment 320 itself.

To generate the semantic representation of the first content, the formative feedback engine 308 may include a vectorization module 324. The vectorization module 324 may vectorize the first content (e.g., the introduction section) to form the semantic representation of the introduction section (458). As illustrated, to perform the vectorization process, the vectorization module 324 may include various components, such as a text preprocessor 326, an embedding module 328, a vector normalization module 330, and a representation generator 332. Each of these components is described in turn below.

When the written assessment 320 is received, and in some cases, the first content identified, the text preprocessor 326 may submit the first content to one or more preprocesses. The text preprocessor 326 may tokenize the introduction section (e.g., first content), breaking it into smaller units such as words or subwords, and may normalize it by removing unnecessary elements like punctuation, stopwords, or special characters. Additionally, the text preprocessor 326 may convert the text within the introduction section to lowercase to ensure uniformity, making the downstream processing more accurate. Once the introduction section is processed by the text preprocessor 326, the tokenized text of the first content may be provided to the embedding module 328.

The embedding module 328 may receive the tokenized text of the first content and transform each token or word into a numerical vector in a high-dimensional space. The embedding module 328 may capture the semantic meaning of the text by mapping similar words or phrases to nearby points in the vector space. By using pre-trained word embeddings or generating custom embeddings based on the dataset, the vectorization module 324 may identify patterns and relationships between words in the introduction section, ensuring that the semantic content may be accurately represented for analysis. To perform one or more of these steps, the embedding module 328 may include one or more embedding models, such as word2vec, GloVe, or BERT, which generate vectorized representations of the input text based on different approaches to capturing semantic meaning and contextual relationships.

Once the vectorized representation of the first content is generated by the embedding module 328, the vector normalization module 330 may standardize the generated vectors to maintain consistency across different inputs. By normalizing the vectors, the vectorization module 324 may ensure that the vectors are on the same scale and orientation, allowing for effective comparison or combination of vectors from various sections. That is, the vector normalization module 330 may prevent distortions in the semantic representation and ensure that the introduction's content is captured in a balanced way. From there, the representation generator 332 may combine the normalized vectors into a unified semantic representation of the entire introduction section (e.g., first content). This representation may encapsulate the key themes, relationships, and overall meaning of the introduction in a compact vector form, herein referred to as a semantic representation.

Responsive to generating the semantic representation, the formative feedback engine 308 may determine textual feedback based on the semantic representation (460). To determine textual feedback based on the semantic representation, the formative feedback engine 308 may include a textual feedback module 334. As illustrated, the textual feedback module 334 may include a textual feedback identifier 338 and a semantic store 336. It should be appreciated that while the semantic store 336 is illustrated as part of the formative feedback engine 308, in some embodiments, the semantic store 336 may be stored or hosted remotely, such as by the application service 101 or a third party.

The semantic store 336 may include an index of previous feedback generated by users, such as educators, along with the corresponding content to which the feedback was given. That is, the semantic store 336 may include semantic representations of previously submitted written assessments or semantic representations of content from previously submitted written assessments that are indexed and associated with feedback provided by a respective reviewing user (e.g., educator). In some embodiments, additional metadata may be associated with each indexed representation, such as a user profile or identifier of the reviewing user, a class or subject matter of the written assessment, a grade level or age of the submitting population (e.g., students), and the like. As will be described in greater detail below, such metadata may be used to identify textual feedback that is relevant to the first content of the written assessment 320.

Responsive to receiving the semantic representation of the first content, the textual feedback identifier 338 may query the semantic store 336 to determine semantically equivalent content to the semantic representation (hereinafter referred to as “semantically equivalent content”) (462). To identify semantically equivalent content to the semantic representation, the textual feedback identifier 338 may calculate the similarity between vectors of the semantically equivalent content and the semantic representation, such as by measuring the distance between them in the vector space. This process may involve using a metric such as cosine similarity, where the textual feedback identifier 338 computes the cosine of the angle between two vectors. If the vectors point in similar directions, the cosine value may be close to 1, indicating higher similarity. Alternatively, the textual feedback identifier 338 may use Euclidean distance, where shorter distances suggest that the vectors, and thus the content, are more closely related.

Once the similarity or distance values are calculated, the textual feedback identifier 338 may determine how to interpret those values. In an example, the textual feedback identifier 338 may apply a threshold, such that content with a similarity score above a certain value is flagged as being highly similar to the semantic representation. In other cases, the textual feedback identifier 338 may rank a subset of semantically equivalent content based on their similarity scores, with the highest-ranking content indicating the closest match. The closest matching semantically equivalent content may be selected by the textual feedback identifier 338 as the semantically equivalent content to the semantic representation. Once semantically equivalent content that matches or is most similar to the semantic representation of the first content is identified, the textual feedback identifier 338 may determine the textual feedback associated with the semantically equivalent content.

In some embodiments, the textual feedback identifier 338 may identify a subset of semantically equivalent content and identify the textual feedback associated with each one. The textual feedback identifier 338 may then filter the subset of semantically equivalent content (or a subset of textual feedback) based on the metadata associated with the content and/or the respective textual feedback. For example, in some embodiments the semantic store 336 may include indexed representations and associated feedback from multiple reviewing users (e.g., educators) across various topics and grade levels. As such, the textual feedback identifier 338 may filter the subset of semantic representation content based on the metadata, such as by reviewing user, to identify textual feedback corresponding to a specific educator, subject matter, student age or grade level, the written assessment 320 type, and the like.

As can be appreciated, different educators may focus on particular skills or aspects of writing and thus identifying textual feedback associated with a particular educator may allow the formative feedback engine 308 to generate commentary insights 116 that align with that educator's feedback style. Similarly, textual feedback on a lab report submitted by seniors in high school may require different content and style than textual feedback for an essay on “My Favorite Animal and Why I Like It” submitted by a 4^{th} grader. Accordingly, identifying textual feedback or semantically equivalent content based on metadata that is similar to the written assessment 320 may provide for more adequate and accurate commentary insights 116.

In some embodiments, one or more of the above described functions of the textual feedback identifier 338 may be part of a Retrieval-Augmented Generation (RAG) operation. That is, the textual feedback identifier 338 may employ a RAG operation to identify textual feedback for the semantic representation of first content. In such cases, the textual feedback identifier 338 may retrieve the textual feedback from the semantic store 336, which as noted above is a repository containing pre-encoded or indexed content and associated textual feedback linked to similar or related content. The textual feedback identifier 338 may initiate the RAG process by generating a query based on the semantic representation and retrieving the textual feedback from the semantic store 336. By using a RAG operation, the textual feedback identifier 338 can ensure that the textual feedback provided aligns closely with the meaning and context of the first content.

Once the textual feedback is identified, the formative feedback engine 308 may generate a commentary insight for the first content (464). The commentary insight may be generated based on the textual feedback, and in some cases, the first content, the semantic representation, and/or the semantically equivalent content. To generate the commentary insight, the formative feedback engine 308 may include a commentary insight module 340. The commentary insight module 340 may include a prompt generator 342, a content generator 312, and a modification module 344.

To generate the commentary insight, the prompt generator 342 may generate a feedback input containing the textual feedback and, in some cases, the first content or semantic representation of the first content (466). The commentary insight module 340 may provide the feedback input to the content generator 312 (468), which may responsively generate the commentary insight. The feedback input may include the textual feedback and a request for the content generator 312 to generate a commentary insight based on the textual feedback for the first content. In some cases, the feedback input may request that the commentary insight be generated in a feedback style or voice of the reviewing user (e.g., educator). In other cases, the feedback input may include more context for the commentary insight, such as the instructions for or topic of the written assessment 320.

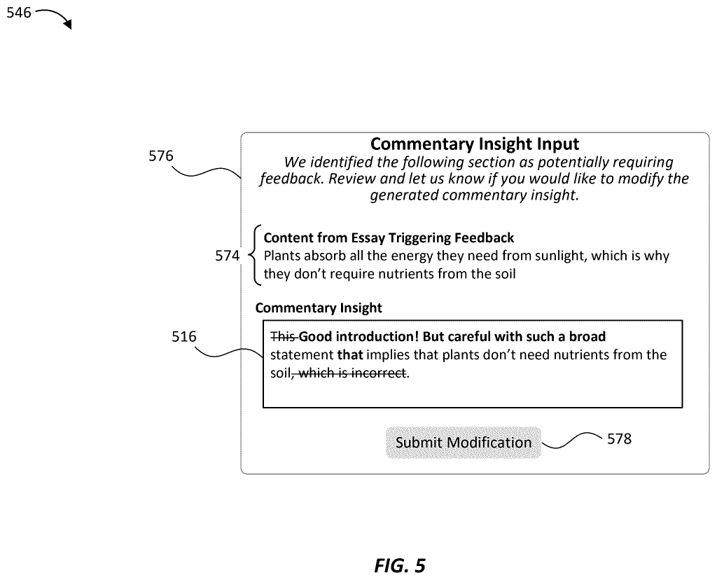

Responsive to receiving the commentary insight as generated by the content generator 312, the modification module 344 may generate a prompt 346 containing the commentary insight. The prompt 346 may be provided to the reviewing user, such as to the client device 306, requesting the user review and provide any modifications/edits to the commentary insight as needed. Referring now to FIG. 5, an example prompt 546 requesting input on a commentary insight 516 is illustrated, according to an embodiment herein. As shown, the prompt 546 includes a note 576 indicating that the formative feedback engine 308 identified content 574 within the written assessment 320 necessitating feedback and generated the commentary insight 516 responsively. The prompt 546 may identify the content 574 for which the commentary insight 516 was generated and/or for which it is providing feedback. As illustrated, the reviewing user, such as via the client device 306, may modify or edit the commentary insight 516 as generated by the formative feedback engine 308. Once the reviewing user makes his or her edits, the user can select the option 578 to submit the modification. Although not illustrated, in some embodiments the prompt 546 may include an option to remove the commentary insight 516 completely.

Once the reviewing user submits the modifications to the commentary insight 516, the formative feedback engine 308 may receive an input 348 from the client device 306 containing the modifications or instructions to remove the commentary insight. Responsive to receiving the input 348, the formative feedback engine 308 may update the commentary insights 316 to reflect the input 348 and provide the commentary insights 316 to the client device 304 (470). In some embodiments, the commentary insights 316 may be displayed within the written assessment 320 to provide context to the user of the client device 304 (472). For example, each of the commentary insights 316, or an indicator thereof, may be displayed within visual proximity to respective content within the written assessment 320.

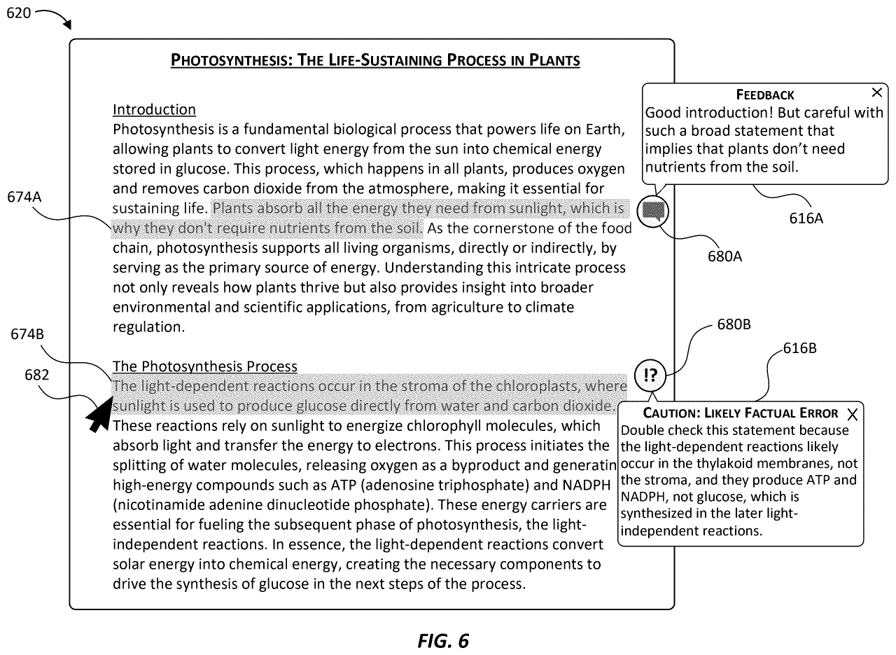

Referring now to FIG. 6, an example written assessment 620 containing commentary insights 616A-B is illustrated, according to an embodiment herein. As illustrated, the written assessment 620, which may be similar to the written assessment 320, may be an essay on Photosynthesis. Within the written assessment 620 the formative feedback engine 308 identified two contents 674A-B for which the commentary insight 616A-B were generated, respectively. As illustrated, the commentary insight 616A is displayed within visual proximity to the content 674A to provide content and indicate that the commentary insight 616A is associated with the content 674A. The commentary insight 616B is similarly displayed with respect to the content 674B.

The formative feedback engine 308 may also include other visual cues to alert the user (e.g., student) of the commentary insights 616A-B. For example, as illustrated, each of the contents 674A-B are highlighted. In other scenarios, the formative feedback engine 308 may underline, bold, italicize, change font color, and/or modify the text of the contents 674A-B in a manner to alert the drafting user of the feedback. In some cases, modifying the text of the contents 674A-B may indicate that there is feedback on that content and as such, the user can select, such as via a cursor 682, the contents 674A-B to review the respective commentary insight 616A-B. In some cases, an icon 680A-B may be provided for each of the contents 674A-B, respectively. Similarly, the user can select one of the icons 680A-B and be provided with the respective commentary insights 616A-B. As can be appreciated, it may be desirable to hide the commentary insights 616A-B until the user selects the respective content 674A-B to avoid cluttering the written assessment 320. In some embodiments, the icons 680A-B may reflect the type of commentary insight 616A-B that is being provided.

Returning to FIG. 3, as noted above, the formative feedback engine 308 may identify content issues within the written assessment 320, such as factual errors, miswording, contradictions, and feedback not identified by the textual feedback module 334. In such cases, the formative feedback engine 308 may include a content issue identifier 350. The content issue identifier 350 may parse the written assessment 320 to identify content issues. To identify content issues, such as contradictions or factual errors in the written assessment 320, the content issue identifier 350 may parse and tokenize the text, breaking it down into sentences, phrases, or key concepts. In some cases, instead of parsing and tokenizing the content of the written assessment 320 itself, the content issue identifier 350 may receive the preprocessed and tokenized content from the vectorization module 324. From the tokenized content, the content issue identifier 350 may identify or isolate specific claims or statements made by the user (e.g., writer).

Once the claims of the written assessment 320 content, such as the first content, are identified, the content issue identifier 350 may compare the claims against knowledge sources or databases 352. The knowledge databases 352 may be grounded on material or documents fed to the formative feedback engine 308, such as textbooks, teaching materials, or articles, that may be provided by the reviewing user or other educational provisioners. If any claim deviates from verified facts or known information, the content issue identifier 350 may flag it as a potential factual error. It should be appreciated that while the knowledge databases 352 are illustrated as part of the formative feedback engine 308, in some embodiments, the knowledge databases 352 may be hosted or otherwise provided separate from the formative feedback engine 308.

To detect contradictions, the content issue identifier 350 may analyze the logical consistency of the text by examining statements throughout the written assessment 320. By tracking related concepts and propositions, the content issue identifier 350 may identify instances where two statements conflict with each other. To perform such analysis, the content issue identifier 350 may perform one or more natural language processes (NLP) to assess the meaning behind each claim, even if the wording differs, to recognize contradictions. Additionally, in some embodiments, the content issue identifier 350 may rely on contextual understanding, optionally aided by artificial intelligence (AI) or generative models like BERT or GPT, to interpret deeper meanings in the text. For example, the content issue identifier 350 may be in operable communication with the content generator 312 to identify content issues, such as contradictory statements. By coordinating with the content generator 312 and/or other AI models, the content issue identifier 350 may detect indirect contradictions, such as scientific inaccuracies or logical inconsistencies based on the context of the written assessment 320.

Once content issues are detected, the content issue identifier 350 may generate a commentary insight for each of the identified content issues. To generate the commentary insight for a content issue, the content issue identifier may provide the content issues to the commentary insight module 340, requesting a commentary insight be generated based on the content issue. As described above, the commentary insight module 340 may generate the commentary insight by submitting a feedback input containing the content issues to the content generator 312, which may responsively generate the commentary insight. Similarly, the commentary insight based on the content issue may be provided via the prompt 346 to the client device 306 for review by the reviewing user.

Referring again to FIG. 6, the commentary insight 616B may be feedback generated based on a content issue within the written assessment 620. For example, the statement made within the content 674B may be factually incorrect, stating that light-dependent reactions of photosynthesis occur in the stroma of plants. As pointed out by the commentary insight 616B, this statement is incorrect because the light-dependent reactions occur in the thylakoid membranes not the stroma.

Once the commentary insights 316 are finalized and approved by reviewing user of the client device 306, such as after they are provided to the drafting user via the client device 304, the formative feedback engine 308 may index the commentary insights 316 and respective content within the semantic store 336 as textual feedback associated with the respective semantic representations. In this manner, the semantic store 336 may gather new material and datapoints in an on-going manner.

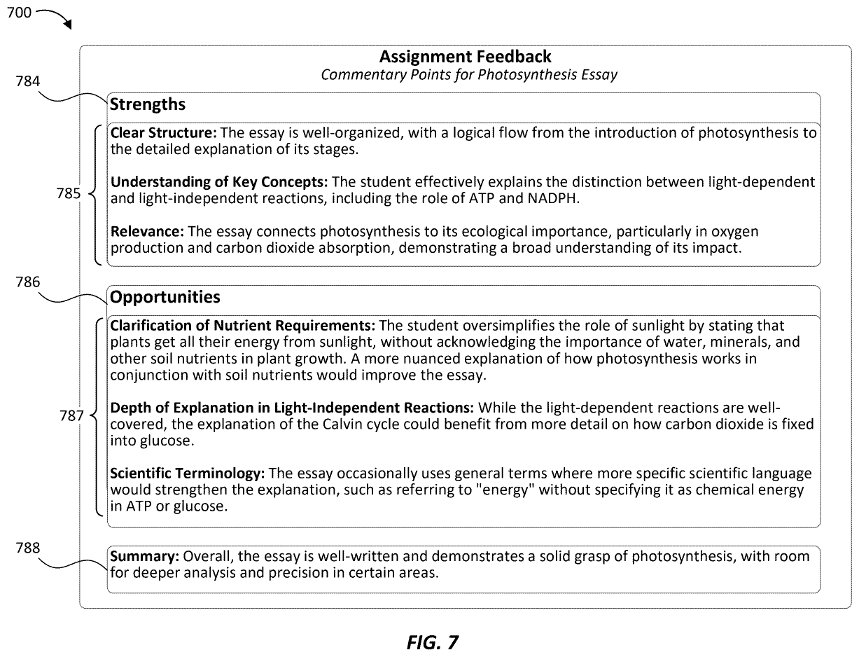

In some embodiments, once the written assessment 320 is submitted and the commentary insights 316 approved by the reviewing user are provided to the client device 304, the formative feedback engine may generate a summary of the commentary insights 316. Referring now to FIG. 7, an example summary 700 of the commentary insights 316 for the written assessment 320 is illustrated, according to an embodiment herein. The formative feedback engine 308 may generate the summary 700 after completion of the written assessment 320 and provide the summary 700 to the client device 306. As shown, the summary 700 may include a summary of strengths 784 and opportunities 786 for growth based on the commentary insights 316 generated by the formative feedback engine 308. In some cases, the summary 700 may include the commentary insights 316 and the respective content for each insight, while in other embodiments, the summary 700 may include the summarization of the commentary insights 316, such as illustrated.

As shown, the strengths 784 may include a section 785 that outlines what the user did correctly within the written assessment 320, while the opportunities 786 may include a section 787 outlining what areas the user has room to improve on. To generate one or both of these sections, the formative feedback engine 308 may submit the commentary insights 316, and in some cases the written assessment 320, to the content generator 312 requesting a summary of the feedback. In some embodiments, the summary 700 may include a summary section 788 that provides a concise statement on the user's overall performance of the written assessment 320. As should be appreciated, while the above discussion is with respect to providing the summary 700 to the reviewing user, if the user (e.g., student) is drafting the written assessment 320 in a personal capacity, such as to practice his or her writing skills, then the summary 700 may be provided to the client device 304.

Referring to FIG. 8, FIG. 8 illustrates a computing system 891 that may be used for providing a formative feedback engine and related functions, as described herein. For example, the client devices 102, 104, or 106 may be or include the computing system 891. As illustrated, the computing system 891 includes a processing system 892 that includes a microprocessor and other circuitry that retrieves and executes software 895 from storage system 893. The processing system 892 may be implemented within a single processing device but may also be distributed across multiple processing devices or sub-systems that cooperate in executing program instructions. Examples of the processing system 892 include general purpose central processing units, graphical processing units, application specific processors, and logic devices, as well as any other type of processing device, combinations, or variations thereof.

The storage system 893 may comprise any computer readable storage media readable by processing system 892 and capable of storing software 895. The storage system 893 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations the storage system 893 may also include computer readable communication media over which at least some of the software 895 may be communicated internally or externally. The storage system 893 may be implemented as a single storage device but may also be implemented across multiple storage devices or sub-systems co-located or distributed relative to each other. The storage system 893 may comprise additional elements, such as a controller capable of communicating with the processing system 892 or possibly other systems.

The software 895 (including formative feedback engine process 896) may be implemented in program instructions and among other functions may, when executed by the processing system 892, direct the processing system 892 to operate as described with respect to the various operational scenarios, sequences, and processes illustrated herein. For example, the software 895 may include program instructions for implementing a formative feedback engine and related functions, such as the process 400 as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. The software 895 may include additional processes, programs, or components, such as operating system software, virtualization software, or other application software. The software 895 may also comprise firmware or some other form of machine-readable processing instructions executable by the processing system 892.

In general, the software 895 may, when loaded into the processing system 892 and executed, transform a suitable apparatus, system, or device (of which computing system 891 is representative) overall from a general-purpose computing system into a special-purpose computing system customized to generate features, functionality, and user experiences provided by the formative feedback engine. Indeed, encoding the software 895 on the storage system 893 may transform the physical structure of the storage system 893. The specific transformation of the physical structure may depend on various factors in different implementations of this description. Examples of such factors may include, but are not limited to, the technology used to implement the storage media of the storage system 893 and whether the computer-storage media are characterized as primary or secondary storage, as well as other factors.

For example, if the computer readable storage media are implemented as semiconductor-based memory, the software 895 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 897 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between the computing system 891 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

Examples are described herein in the context of systems and methods for providing a formative feedback engine and related functions. Those of ordinary skill in the art will realize that the foregoing description is illustrative only and is not intended to be in any way limiting. Reference is made in detail to implementations of examples as illustrated in the accompanying drawings. The same reference indicators will be used throughout the drawings and the following description to refer to the same or like items.

Additionally, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure. In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a system comprising: one or more computer readable storage media; one or more processors operatively coupled with the one or more computer readable storage media; and an application comprising program instructions stored on the one or more computer readable storage media that, when executed by the one or more processors, direct a computing system to at least: determine, by a formative feedback engine, a written assessment associated with a first client device; determine, by the formative feedback engine, first content of the written assessment; vectorize, by the formative feedback engine, the first content to form a semantic representation of the first content; identify, by the formative feedback engine, semantically equivalent content to the semantic representation of the first content; determine, by the formative feedback engine, textual feedback associated with the semantically equivalent content; generate, by the formative feedback engine, a first commentary insight for the first content based on the textual feedback; and provide, by the formative feedback engine, the first commentary insight for the written assessment to a client device.

Example 2 is the system of any previous or subsequent Example, wherein the program instructions to generate, by the formative feedback engine, the commentary insight for the first content based on the textual feedback, when executed by the one or more processors, further direct the computing system to: generate, by the formative feedback engine, a feedback input comprising the textual feedback and the first content; transmit, by the formative feedback engine, the feedback input to a content generator; and receive, by the formative feedback engine, the commentary insight from the content generator, wherein the commentary insight rephrases the textual feedback based on the first content.

Example 3 is the system of any previous or subsequent Example, wherein the program instructions, when executed by the one or more processors, further direct the computing system to: parse, by the formative feedback engine, the written assessment to identify one or more content issues; and generate, by the formative feedback engine, a second commentary insight based on the one or more content issues.

Example 4 is the system of any previous or subsequent Example, wherein the program instructions to provide, by the formative feedback engine, the first commentary insight for the written assessment to the client device, when executed by the one or more processors, further direct the computing system to: display, by the formative feedback engine, the first commentary insight on the written assessment within visual proximity to the first content.

Example 5 is the system of any previous or subsequent Example, wherein the program instructions, when executed by the one or more processors, further direct the computing system to: associate, by the formative feedback engine, the semantic representation of the first content with the first commentary insight; and index, by the formative feedback engine, the semantic representation and the first commentary insight in the semantic store.

Example 6 is the system of any previous or subsequent Example, wherein the program instructions, when executed by the one or more processors, further direct the computing system to: receive, by the formative feedback engine, a modification to the first commentary insight from the client device; generate, by the formative feedback engine, a modified commentary insight for the first content based on the modification; and provide, by the formative feedback engine, the modified commentary insight as associated with the first content within the written assessment.

Example 7 is a method comprising: receiving, from a client device, a written assessment comprising first content; generating, by a formative feedback engine, a semantic representation of the first content; querying, by the formative feedback engine, a semantic store based on the semantic representation of the first content, wherein the semantic store comprises a plurality of commentary insights associated with one or more previously evaluated written assessments; determining, by the formative feedback engine, textual feedback from the semantic store based on the semantic representation of the first content; generating, by the formative feedback engine, a commentary insight for the first content based on the textual feedback and the first content; and providing, by the formative feedback engine, the commentary insight to the client device.

Example 8 is the method of any previous or subsequent Example, wherein generating, by the formative feedback engine, the commentary insight for the first content based on the textual feedback and the first content comprises: generating, by the formative feedback engine, a feedback input comprising the textual feedback and the first content; providing, by the formative feedback engine, the feedback input to a content generator, wherein the content generator generates the commentary insight responsive to receiving the feedback input; and receiving, by the formative feedback engine, the commentary insight from the content generator.

Example 9 is the method of any previous or subsequent Example, wherein the method further comprises: analyzing, by the formative feedback engine, the written assessment for a content issue, wherein the content issue comprises one or more of a factual error, a wording error, or a concept contradiction; determining, by the formative feedback engine, that second content within the written assessment comprises the content issue; generating, by the formative feedback engine, a second commentary insight identifying the content issue; and providing, by the formative feedback engine, the second commentary insight as associated with the second content within the written assessment.

Example 10 is the method of any previous or subsequent Example, wherein determining, by the formative feedback engine, the textual feedback from the semantic store based on the semantic representation of the first content comprises: determining, by the formative feedback engine, a plurality of semantically equivalent content based on the semantic representation; determining, by the formative feedback engine, a subset of semantically equivalent content from the plurality of semantically equivalent content based on the client device; ranking, by the formative feedback engine, the subset of semantically equivalent content by degree of similarity to the semantic representation of the first content; determining, by the formative feedback engine, a first semantically equivalent content based on the ranking; and determining, by the formative feedback engine, the textual feedback associated with the first semantically equivalent content.

Example 11 is the method of any previous or subsequent Example, wherein generating, by the formative feedback engine, a commentary insight for the first content based on the textual feedback and the first content further comprises: determining, by the formative feedback engine, a writing style associated with the client device; and generating, by the formative feedback engine, the commentary insight in the writing style of the client device.

Example 12 is the method of any previous or subsequent Example, wherein querying, by the formative feedback engine, the semantic store based on the semantic representation of the first content and determining, by the formative feedback engine, the textual feedback from the semantic store based on the semantic representation of the first content comprises: performing, by the formative feedback engine, a Retrieval-Augmented Generation (RAG) operation for the semantic representation of the first content using the semantic store; and determining, by the formative feedback engine, the textual feedback from the RAG operation.

Example 13 is the method of any previous or subsequent Example, wherein the method further comprises: determining, by the formative feedback engine, a plurality of commentary insights associated with the written assessment, wherein each of the commentary insights corresponds to respective content within the written assessment; associating, by the formative feedback engine, each of the commentary insights with the respective content; and indexing, by the formative feedback engine, the plurality of commentary insights and the respective content in the semantic store.

Example 14 is the method of any previous or subsequent Example, the method further comprising: receiving, by the formative feedback engine, a modification to the commentary insight from the client device; generating, by the formative feedback engine, a modified commentary insight for the first content based on the modification; and providing, by the formative feedback engine, the modified commentary insight as associated with the first content within the written assessment.

Example 15 is a computer readable storage media comprising processor-executable instructions configured to cause one or more processors to: determine, by a formative feedback engine, a written assessment comprising first content; vectorize, by a formative feedback engine, the first content to form a first semantic representation of the first content; compare, by the formative feedback engine, the first semantic representation to a semantic store; identify, by the formative feedback engine, a first textual feedback based on the comparison of the first semantic representation to the semantic store; generate, by the formative feedback engine, a first commentary insight for the first content based on the first textual feedback; and provide, by the formative feedback engine, the first commentary insight as associated with the first content within the written assessment.

Example 16 is the computer readable storage media of any previous or subsequent Example, wherein the processor-executable instructions to identify, by the formative feedback engine, the first textual feedback based on the comparison of the first semantic representation to the semantic store cause the one or more processors to further execute processor-executable instructions stored in the computer readable storage media to: determine, by the formative feedback engine, semantically equivalent content to the first content within the semantic store; and determine, by the formative feedback engine, the first textual feedback as associated with the semantically equivalent content.

Example 17 is the computer readable storage media of any previous or subsequent Example, wherein the written assessment comprises second content, and the processor-executable instructions cause the one or more processors to further execute processor-executable instructions stored in the computer readable storage media to: determine, by the formative feedback engine, that the second content comprises a content issue; and generate, by the formative feedback engine, a second commentary insight based on the content issue, wherein the second commentary insight identifies the content issue within the second content.

Example 18 is the computer readable storage media of any previous or subsequent Example, wherein the processor-executable instructions cause the one or more processors to further execute processor-executable instructions stored in the computer readable storage media to: determine, by the formative feedback engine, completion of the written assessment, wherein upon completion the written assessment comprises a plurality of commentary insights; and generate, by the formative feedback engine, a summary of the commentary insights for the written assessment.

Example 19 is the computer readable storage media of any previous or subsequent Example, wherein the processor-executable instructions to identify, by the formative feedback engine, the first textual feedback based on the comparison of the first semantic representation to the semantic store cause the one or more processors to further execute processor-executable instructions stored in the computer readable storage media to: determine, by the formative feedback engine, a client device associated with the writing assessment; determine, by the formative feedback engine, a plurality of semantically equivalent content to the first semantic representation within the semantic store; determine, by the formative feedback engine, a plurality of textual feedback based on the plurality of semantically equivalent content, wherein each of the textual feedback within the plurality of textual feedback corresponds to a respective semantically equivalent content of the plurality of semantically equivalent content; determine, by the formative feedback engine, a subset of textual feedback from the plurality of textual feedback based on the client device; rank, by the formative feedback engine, the subset of textual feedback by degree of similarity between a subset of semantically equivalent content to the first semantic representation, wherein the subset of semantically equivalent content corresponds to the subset of textual feedback; determine, by the formative feedback engine, a first semantically equivalent content based on the ranking; and determine, by the formative feedback engine, the textual feedback as associated with the first semantically equivalent content.

Example 20 is the computer readable storage media of any previous or subsequent Example, wherein the processor-executable instructions to identify, by the formative feedback engine, the first textual feedback based on the comparison of the first semantic representation to the semantic store cause the one or more processors to further execute processor-executable instructions stored in the computer readable storage media to: perform, by the formative feedback engine, a Retrieval-Augmented Generation (RAG) operation for the first semantic representation using the semantic store; and determine, by the formative feedback engine, the first textual feedback from the RAG operation.

What is claimed is:

1. A system comprising:
one or more computer readable storage media;
one or more processors operatively coupled with the one or more computer readable storage media; and
an application comprising program instructions stored on the one or more computer readable storage media that, when executed by the one or more processors, direct a computing system to at least:
determine, by a formative feedback engine, a written assessment associated with a first client device;
determine, by the formative feedback engine, first content of the written assessment;
vectorize, by the formative feedback engine, the first content to form a semantic representation of the first content;
identify, by the formative feedback engine, semantically equivalent content to the semantic representation of the first content;
determine, by the formative feedback engine, textual feedback associated with the semantically equivalent content;
generate, by the formative feedback engine, a first commentary insight for the first content based on the textual feedback; and
provide, by the formative feedback engine, the first commentary insight for the written assessment to a client device.

2. The system of claim 1, wherein the program instructions to generate, by the formative feedback engine, the commentary insight for the first content based on the textual feedback, when executed by the one or more processors, further direct the computing system to:
generate, by the formative feedback engine, a feedback input comprising the textual feedback and the first content;
transmit, by the formative feedback engine, the feedback input to a content generator; and
receive, by the formative feedback engine, the commentary insight from the content generator, wherein the commentary insight rephrases the textual feedback based on the first content.

3. The system of claim 1, wherein the program instructions, when executed by the one or more processors, further direct the computing system to:
parse, by the formative feedback engine, the written assessment to identify one or more content issues; and
generate, by the formative feedback engine, a second commentary insight based on the one or more content issues.

4. The system of claim 1, wherein the program instructions to provide, by the formative feedback engine, the first commentary insight for the written assessment to the client device, when executed by the one or more processors, further direct the computing system to:
display, by the formative feedback engine, the first commentary insight on the written assessment within visual proximity to the first content.

5. The system of claim 1, wherein the program instructions, when executed by the one or more processors, further direct the computing system to:
associate, by the formative feedback engine, the semantic representation of the first content with the first commentary insight; and
index, by the formative feedback engine, the semantic representation and the first commentary insight in a semantic store.

6. The system of claim 1, wherein the program instructions, when executed by the one or more processors, further direct the computing system to:
receive, by the formative feedback engine, a modification to the first commentary insight from the client device;
generate, by the formative feedback engine, a modified commentary insight for the first content based on the modification; and
provide, by the formative feedback engine, the modified commentary insight as associated with the first content within the written assessment.

7. A method comprising:
receiving, from a client device, a written assessment comprising first content;
generating, by a formative feedback engine, a semantic representation of the first content;
querying, by the formative feedback engine, a semantic store based on the semantic representation of the first content, wherein the semantic store comprises a plurality of commentary insights associated with one or more previously evaluated written assessments;
determining, by the formative feedback engine, textual feedback from the semantic store based on the semantic representation of the first content;
generating, by the formative feedback engine, a commentary insight for the first content based on the textual feedback and the first content; and
providing, by the formative feedback engine, the commentary insight to the client device.

8. The method of claim 7, wherein generating, by the formative feedback engine, the commentary insight for the first content based on the textual feedback and the first content comprises:
generating, by the formative feedback engine, a feedback input comprising the textual feedback and the first content;
providing, by the formative feedback engine, the feedback input to a content generator, wherein the content generator generates the commentary insight responsive to receiving the feedback input; and
receiving, by the formative feedback engine, the commentary insight from the content generator.

9. The method of claim 7, wherein the method further comprises:
analyzing, by the formative feedback engine, the written assessment for a content issue, wherein the content issue comprises one or more of a factual error, a wording error, or a concept contradiction;
determining, by the formative feedback engine, that second content within the written assessment comprises the content issue;
generating, by the formative feedback engine, a second commentary insight identifying the content issue; and
providing, by the formative feedback engine, the second commentary insight as associated with the second content within the written assessment.

10. The method of claim 7, wherein determining, by the formative feedback engine, the textual feedback from the semantic store based on the semantic representation of the first content comprises:
determining, by the formative feedback engine, a plurality of semantically equivalent content based on the semantic representation;
determining, by the formative feedback engine, a subset of semantically equivalent content from the plurality of semantically equivalent content based on the client device;
ranking, by the formative feedback engine, the subset of semantically equivalent content by degree of similarity to the semantic representation of the first content;
determining, by the formative feedback engine, a first semantically equivalent content based on the ranking; and
determining, by the formative feedback engine, the textual feedback associated with the first semantically equivalent content.

11. The method of claim 7, wherein generating, by the formative feedback engine, a commentary insight for the first content based on the textual feedback and the first content further comprises:
determining, by the formative feedback engine, a writing style associated with the client device; and
generating, by the formative feedback engine, the commentary insight in the writing style of the client device.

12. The method of claim 7, wherein querying, by the formative feedback engine, the semantic store based on the semantic representation of the first content and determining, by the formative feedback engine, the textual feedback from the semantic store based on the semantic representation of the first content comprises:
performing, by the formative feedback engine, a Retrieval-Augmented Generation (RAG) operation for the semantic representation of the first content using the semantic store; and
determining, by the formative feedback engine, the textual feedback from the RAG operation.

13. The method of claim 7, wherein the method further comprises:
determining, by the formative feedback engine, a plurality of commentary insights associated with the written assessment, wherein each of the commentary insights corresponds to respective content within the written assessment;
associating, by the formative feedback engine, each of the commentary insights with the respective content; and
indexing, by the formative feedback engine, the plurality of commentary insights and the respective content in the semantic store.

14. The method of claim 7, the method further comprising:
receiving, by the formative feedback engine, a modification to the commentary insight from the client device;
generating, by the formative feedback engine, a modified commentary insight for the first content based on the modification; and
providing, by the formative feedback engine, the modified commentary insight as associated with the first content within the written assessment.

15. A computer readable storage media comprising processor-executable instructions configured to cause one or more processors to:
determine, by a formative feedback engine, a written assessment comprising first content;
vectorize, by a formative feedback engine, the first content to form a first semantic representation of the first content;
compare, by the formative feedback engine, the first semantic representation to a semantic store;
identify, by the formative feedback engine, a first textual feedback based on the comparison of the first semantic representation to the semantic store;
generate, by the formative feedback engine, a first commentary insight for the first content based on the first textual feedback; and
provide, by the formative feedback engine, the first commentary insight as associated with the first content within the written assessment.

16. The computer readable storage media of claim 15, wherein the processor-executable instructions to identify, by the formative feedback engine, the first textual feedback based on the comparison of the first semantic representation to the semantic store cause the one or more processors to further execute processor-executable instructions stored in the computer readable storage media to:
determine, by the formative feedback engine, semantically equivalent content to the first content within the semantic store; and
determine, by the formative feedback engine, the first textual feedback as associated with the semantically equivalent content.

17. The computer readable storage media of claim 15, wherein the written assessment comprises second content, and the processor-executable instructions cause the one or more processors to further execute processor-executable instructions stored in the computer readable storage media to:
determine, by the formative feedback engine, that the second content comprises a content issue; and
generate, by the formative feedback engine, a second commentary insight based on the content issue, wherein the second commentary insight identifies the content issue within the second content.

18. The computer readable storage media of claim 15, wherein the processor-executable instructions cause the one or more processors to further execute processor-executable instructions stored in the computer readable storage media to:
determine, by the formative feedback engine, completion of the written assessment, wherein upon completion the written assessment comprises a plurality of commentary insights; and
generate, by the formative feedback engine, a summary of the commentary insights for the written assessment.

19. The computer readable storage media of claim 15, wherein the processor-executable instructions to identify, by the formative feedback engine, the first textual feedback based on the comparison of the first semantic representation to the semantic store cause the one or more processors to further execute processor-executable instructions stored in the computer readable storage media to:
determine, by the formative feedback engine, a client device associated with the writing assessment;
determine, by the formative feedback engine, a plurality of semantically equivalent content to the first semantic representation within the semantic store;
determine, by the formative feedback engine, a plurality of textual feedback based on the plurality of semantically equivalent content, wherein each of the textual feedback within the plurality of textual feedback corresponds to a respective semantically equivalent content of the plurality of semantically equivalent content;
determine, by the formative feedback engine, a subset of textual feedback from the plurality of textual feedback based on the client device;
rank, by the formative feedback engine, the subset of textual feedback by degree of similarity between a subset of semantically equivalent content to the first semantic representation, wherein the subset of semantically equivalent content corresponds to the subset of textual feedback;
determine, by the formative feedback engine, a first semantically equivalent content based on the ranking; and
determine, by the formative feedback engine, the textual feedback as associated with the first semantically equivalent content.

20. The computer readable storage media of claim 15, wherein the processor-executable instructions to identify, by the formative feedback engine, the first textual feedback based on the comparison of the first semantic representation to the semantic store cause the one or more processors to further execute processor-executable instructions stored in the computer readable storage media to:
perform, by the formative feedback engine, a Retrieval-Augmented Generation (RAG) operation for the first semantic representation using the semantic store; and
determine, by the formative feedback engine, the first textual feedback from the RAG operation.
